(19) United States
(12) Patent Application Publication
(10) Pub. No.: US 2010/0217647 A1
(43) Pub. Date: Aug. 26, 2010

(54) DETERMINING SHARE OF VOICE

(76) Inventors: Philip Clifford JACOBS, Windham, NH (US); Benjamin Beau Perry, Newark, DE (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/389,692

(22) Filed: Feb. 20, 2009

(51) Int. Cl. G06Q 30/00; G06Q 10/00

(52) U.S. Cl. 705/10; 705/14.49

(57) ABSTRACT

An example embodiment disclosed herein is directed to an apparatus, comprising a communication interface configured to communicate over an associated network, and share of voice analysis logic operable to send and receive data via the communication interface. The share of voice analysis logic is operable to communicate with a device providing advertising coupled to the associated network. The share of voice analysis logic is operable to provide data representative of a targeted profile to the device providing advertising and to receive data representative of at least one advertisement from the device providing the advertising. The share of voice analysis logic is responsive to receiving the data representative of at least one advertisement to analyze the data representative of at least one advertisement to determine a share of voice for at least one advertiser.

### TECHNICAL FIELD

The present disclosure relates generally to analyzing advertising to determine share of voice.

### BACKGROUND

Share of Voice (SOV) is a marketing metric which has multiple uses. Although there are various definitions for SOV, as used herein it can loosely be defined as the percentage of an advertising space that an advertiser covers over a period time, for example Advertiser A's % of available advertising space in a magazine. Traditionally this calculation has been done manually by clipping services, etc. Manual determination of the SOV for an advertiser on the Internet, however, is becoming increasingly impractical because of behavioral targeted advertisement, which can result in different viewers scanning a web page and obtaining different results.

### BRIEF DESCRIPTION OF THE DRAWINGS

The accompanying drawings incorporated herein and forming a part of the specification illustrate the examples embodiments.

FIG. 1 is a block diagram illustrating an example of a network employing an apparatus for determining share of voice configured in accordance with an example embodiment.

FIG. 2 is a block diagram illustrating an example of an apparatus for determining share of voice.

FIG. 3 is a block diagram of a computer system upon which an example embodiment may be implemented.

FIG. 4 is a block diagram of a methodology for analyzing advertisements on a web site in accordance with an example embodiment.

FIG. 5 is a block diagram of a methodology for analyzing advertisements from a plurality of web sites in accordance with an example embodiment.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein, a technique for determining Share of Voice (SOV). The technique may suitably comprise identifying requirements, for example an advertising space of interest. The technique may further comprise acquiring a list of devices, such as computing devices identified by a Uniform Resource Locator (URL), an address that identifies a web site on the Internet. The URLs are intelligently scanned to determine the total available ads and the number of ads per advertiser.

In accordance with an example embodiment, there is disclosed herein an apparatus comprising a communication interface configured to communicate over an associated network, and share of voice analysis logic operable to send and receive data via the communication interface. The share of voice analysis logic is operable to communicate with a device providing advertising coupled to the associated network. The share of voice analysis logic is operable to provide data representative of a targeted profile to the device providing advertising and to receive data representative of at least one advertisement from the device providing the advertising. The share of voice analysis logic is responsive to receiving the data representative of at least one advertisement to analyze the data representative of at least one advertisement to determine a share of voice for at least one advertiser.

In accordance with an example embodiment, there is disclosed herein a method comprising communicating with a device providing advertising coupled to the associated network. Data representative of a targeted profile is provided to the device. Data representative of at least one advertisement is received from the device. A share of voice for at least one advertiser is determined responsive to receiving data representative of at least one advertisement.

In accordance with an example embodiment, there is disclosed herein logic encoded in one or more tangible media for execution and when executed operable to communicate with a device providing advertising coupled to the associated network. The logic provides data representative of a targeted profile to the device. The logic receives data representative of at least one advertisement from the device, and determines a share of voice for at least one advertiser responsive to receiving data representative of at least one advertisement.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In accordance with an example embodiment, there is disclosed herein, a technique for determining Share of Voice (SOV). The technique may suitably comprise identifying requirements, for example an advertising space of interest. The technique may further comprise acquiring a list of devices, such as computing devices identified by a Uniform Resource Locator (URL), an address that identifies a web site on the Internet. The URLs are intelligently scanned to determine the total available ads and the number of ads per advertiser. For example, the “total voice” of all advertisers found on a web page for each type of visitor can be computed. The share of voice for each advertiser is some percentage of the “total voice”. The percentage of the total voice can be expressed in several ways, including but not limited to percent pixels for images, percent pixels for videos, percent video duration of pre-rolls, percent video duration of post-rolls, percent video duration of mid-rolls, percent video duration of overlays, etc.

In accordance with an example embodiment, a targeted profile is sent to the advertising space. In an example embodiment, cookie sets can be manipulated to emulate the targeted profile. Cookie sets may be created on the fly, e.g. an apparatus performing SOV analysis may visit certain web sites to obtain the cookies, or cookie files can be created and stored, and swapped in to emulate the targeted profile. This can allow SOV calculations for behavioral, demographical, contextual, geographic or any desired targeted profile.

Several different techniques may be employed for identifying an advertiser. These may include, but are not limited to, image analysis via neural networks applied to a scaled/edge detected image tree of a static image or several key frames in an audiovisual based advertisement, text analysis using various determining techniques such as clustering or random indexing, audio to text processing on audio based advertisements which can use the aforementioned techniques for text analysis, examining meta data, generating a signature for an advertisement and performing pattern matching, etc. The results may be monitored and verified at times by a user for increased accuracy. For example, a user may determine whether an advertisement is being identified with the correct advertiser or can identify the appropriate advertiser for an advertisement.

The results of the analysis may be used to provide real-time signaling to other systems which may be triggered by predefined SOV conditions. For example, a conditional rule may be defined to initiate a signal if the SOV for an advertiser falls below a threshold. For example, if the SOV for an advertiser is less than 20% than the sum to their 3 largest competitors' SOV's, then a signal can be generated to notify a user or automated program of the condition. The signal may be an audio visual alarm, an email, a log entry or any other predefined action. An example of the action that a user or automated program may take on receiving a signal notification of this condition may be to attempt to increase the advertiser's SOV to a more acceptable level.

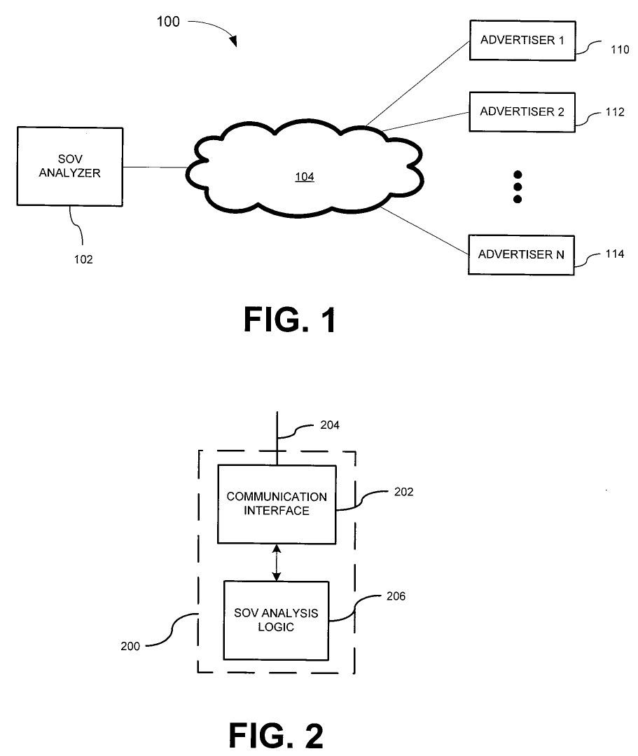

FIG. 1 is a block diagram illustrating an example of a system 100 employing an apparatus 102 for determining share of voice configured in accordance with an example embodiment. In the example embodiment, apparatus 102 is coupled to network 104. Network 104 can be any suitable network employing any suitable networking protocol. Network 104 may suitably comprise wired and/or wireless links. In an example embodiment, network 104 is the Internal, a worldwide packet data communication network. Attached to network 104 are a plurality of computing devices 110, 112, 114 that are providing advertisements, such as computing devices maintaining web sites comprising advertising content. The number of computing devices illustrated in FIG. 1 was merely chosen for ease of illustration and those skilled in the art should readily appreciate that the number may be as few as one or as many as are physically realizable. It should be noted that in an example embodiment devices 110, 112, 114 may actually be providing advertisements from several advertisers. Moreover, the advertisement data may not reside on devices 110, 112, 114. For examples devices 110, 112, 114 may contain links that redirect a browser to one ore more advertising networks.

As will be described in more detail herein infra, apparatus 102 is referred to in FIG. 1 as a Share of Voice (SOV) Analyzer 102. SOV analyzer 102 may be a standalone computing device or may be incorporated in a general purpose computing system. In an example embodiment that will be described herein infra, SOV Analyzer 102 may comprise a communication interface configured to communicate with computing devices via network 104, and share of voice (SOV) analysis logic operable to send and receive data via the communication interface. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software.

The share of voice analysis logic of SOV analyzer 102 is operable to communicate with a device providing advertising coupled to the associated network, such as for example one or more of device (Advertiser 1) 110, device (Advertiser 2) 112 and/or device (Advertiser N) 114 (where N is an integer greater than 2 in the illustrated example—and each advertiser may provide a plurality of advertisements from a variety of different sources). The share of voice analysis logic is operable to provide data representative of a targeted profile to the device providing advertising, e.g. one or more of devices 110, 112 and/or 114, and to receive data representative of at least one advertisement from the device providing the advertising. The share of voice analysis logic of SOV analyzer 102 is responsive to receiving the data representative of at least one advertisement to analyze the data representative of at least one advertisement to determine a share of voice for at least one advertiser.

In an example embodiment, the devices providing advertising (for example one or more of devices 110,112 and/or 114) is a web site and network 104 is the Internet. This would enable SOV analyzer 102 to use well known protocols, such as addressing using Uniform Resource Locators (URLs), to communicate with devices 110, 112 and/or 114. In addition, SOV analyzer 102 may employ cookie files to communicate a targeted profile to devices 110, 112 and/or 114.

In an example embodiment, logic in SOV analyzer 102 provides data of a targeted profile by simulating user data inputs. For example, SOV analyzer 102 may simulate mouse clicks. In an example embodiment, SOV analyzer 102 employs cookie files with data for the targeted profile. In particular embodiments, cookie files and simulated user data inputs are employed. For example, to determine SOV for an automobile manufacturer, logic in SOV analyzer 102 may visit certain websites (such as web sites that advertise automobile and/or automobile loans) to obtain cookies, etc. The logic in SOV analyzer 102 may then visit other sites, such as news websites, for determining a SOV for the automobile manufacturer.

In an example embodiment, SOV analyzer 102 communicates with a plurality of devices 110, 112, 114 to obtain advertising data for a targeted profile. Logic in SOV analyzer 102 communicates with a plurality of advertisers (such as web sites) to determine the share of voice for at least one advertiser, which may list a share of voice for each web site and/or an aggregate share of voice. In an example embodiment, logic in SOV analyzer determines share of voice for all advertisers detected.

In an example embodiment, the logic determines the size of the advertisements. For example, pixels may be counted of advertisements detected on Internet web pages. For audio and/or visual advertisements the amount of time the advertisement is displayed or output.

Various analysis tools may be employed for determining the advertiser for an advertisement. For example, share of voice analysis logic may perform an image analysis of the data representative of at least one advertisement. As another example the logic can perform a text analysis of the data representative of at least one advertisement. Yet another example, the logic can perform an audio to text conversion and a text analysis of the data representative of at least one advertisement. Still another example, the logic can compare signatures of known advertisements with the data representative of at least one advertisement (for example the logic may employ a storage library of identified ads).

In an example embodiment, logic in SOV analyzer 102 can receive data associating at least one advertiser with advertising data. For example, the logic can display an ad and wait for user input identifying the advertiser for the ad. The logic can then store data, such as a signature of the ad (which can be the entire ad or a portion of the ad—such as the first 12 pixels, etc) and a link associating the ad to advertiser. Thus, when SOV analyzer 102 subsequently encounters an ad at one of devices 110, 112 and/or 114, the logic in SOV analyzer 102 can properly determine the advertiser for the ad.

In an example embodiment, SOV analyzer 102 can generate a signal if it determines that the share of voice for an at least one advertiser is less than a predetermined threshold. For example, if an advertiser wants to ensure its share of voice is no less than 20% of an advertisement space, SOV analyzer can send a signal (such as an email, audio, visual and/or audiovisual signal) informing the advertiser when the advertiser's SOV is below 20%.

In an example embodiment, the data analyzed by SOV analyzer 102 further comprises reviews. For example, binary logs (BLOGs) and/or social networks, or web sites providing product reviews may be monitored for comments about predefined products. In particular embodiments, SOV analyzer 102 can also determine whether the comments were favorable or unfavorable and/or determine how many comments were favorable and unfavorable. SOV analyzer 102 may also determine total mentions for all products of a certain type, percent of mentions for each brand or product, and/or share of mentions.

FIG. 2 is a block diagram illustrating an example of an apparatus 200 for determining share of voice. Apparatus 200 is suitable for implementing SOV analyzer 102 described herein in FIG. 1. Apparatus 200 comprises a communication interface 202. Communication interface 202 is configured to communicate over a communication link 204. Communication link 204 can be any wired (e.g. Ethernet, Asynchronous Transfer Mode “ATM”, etc.) or wireless (e.g. electromagnetic, Radio Frequency “RF”, Optical, Infrared “IR”, etc.) link. SOV analysis logic 206 is operative to send and receive data via communication interface 206. For example, SOV analysis logic 206 may select computing devices (e.g. web sites) connected to a network accessible through communication link 204 for determining share of voice for one or more advertisers. SOV analysis logic would communicate with the devices (e.g. web sites) via communication interface 202 which would then establish communication with the device. Share of voice analysis logic 206 is operable to provide data representative of a targeted profile to the device providing the advertisements, e.g. the web sites, and to receive data representative of at least one advertisement from the device providing the advertising via communication interface 202. Share of voice analysis 206 is responsive to receiving the data representative of at least one advertisement to analyze the data representative of at least one advertisement to determine a share of voice for at least one advertiser.

In an example embodiment, the device providing advertisements is a web site coupled to the Internet. This would enable communication interface 202 to use well known protocols, such as addressing using Uniform Resource Locators (URLs), to communicate with devices 110, 112 and/or 114. In addition, SOV analysis logic 206 may employ cookie files to communicate the targeted profile to the advertiser.

In an example embodiment, logic 206 provides data of a targeted profile by simulating user data inputs. For example, logic 206 may simulate mouse clicks and/or provide textual data. In particular embodiments, cookie files may also be employed. In particular embodiments, cookie files are used with simulated user data inputs. For example, to determine SOV for an automobile manufacturer, logic 206 may visit certain websites (such as web sites that advertise automobile and/or automobile loans) to obtain cookies, etc. Logic 206 may then visit targeted sites for determining SOV for the automobile manufacturer.

In an example embodiment, SOV analysis logic 206 communicates with a plurality of advertisers (for example devices 110, 112, 114 in FIG. 1) to obtain advertising data for a targeted profile. SOV analysis logic 206 communicates with a plurality of advertisers (such as web sites) to determine the share of voice for at least one advertiser. In an example embodiment, logic in SOV analyzer determines share of voice for all advertisers detected.

In an example embodiment, the SOV analysis logic 206 determines the size of the advertisements. For example, pixels may be counted of advertisements detected on Internet web pages. For audio and/or visual advertisements the amount of time the advertisement is displayed or output.

Various analysis tools may be employed for determining the advertiser for an advertisement. For example, SOV analysis logic 206 may perform an image analysis of the data representative of at least one advertisement. As another example the SOV analysis logic 206 can perform a text analysis of the data representative of at least one advertisement. Yet another example, the SOV analysis logic 206 can perform an audio to text conversion and a text analysis of the data representative of at least one advertisement. Still another example, SOV analysis logic 206 can compare signatures of known advertisements with the data representative of at least one advertisement.

In an example embodiment, logic in SOV analyzer 102 can receive data associating at least one advertiser with advertising data. For example, SOV analysis logic 206 can display an ad and wait for user input identifying the advertiser for the ad. The logic can then store data, such as a signature of the ad (which can be the entire ad or a portion of the ad—such as the first 12 pixels, 5 frames, etc) and a link associating the ad to and advertiser. Thus, when SOV analysis logic 206 encounters an ad, SOV analysis logic 206 can properly determine the advertiser for the ad.

In an example embodiment, SOV analysis logic 206 can generate a signal if it determines that the share of voice for an at least one advertiser is less than a predetermined threshold. For example, if an advertiser wants to ensure its share of voice is no less than 20% of an advertisement space, SOV analysis logic 206 can send a signal (such as an email, audio, visual and/or audiovisual signal) informing the advertiser when the advertiser's SOV is below 20%.

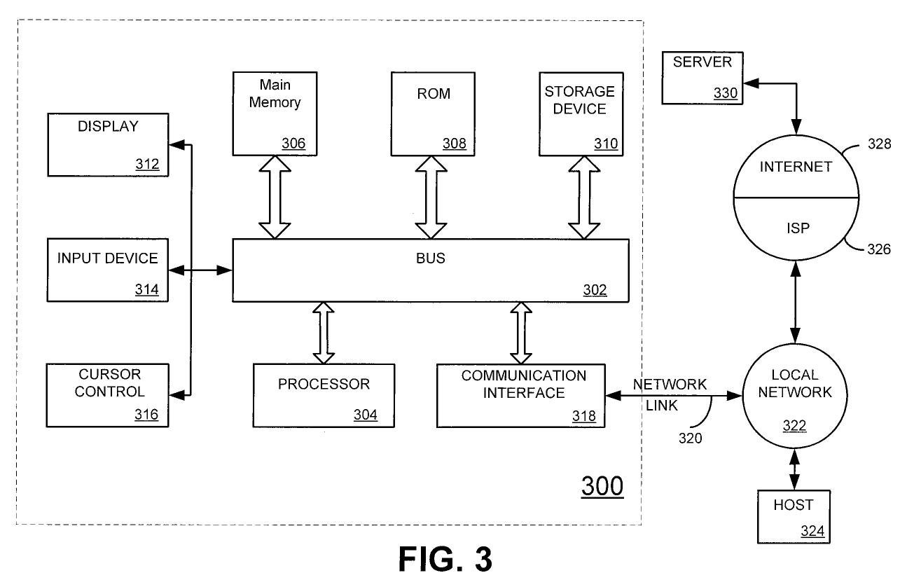

FIG. 3 is a block diagram of a computer system 300 upon which an example embodiment may be implemented. Computer system 300 includes a bus 302 or other communication mechanism for communicating information and a processor 304 coupled with bus 302 for processing information. Computer system 300 also includes a main memory 306, such as random access memory (RAM) or other dynamic storage device coupled to bus 302 for storing information and instructions to be executed by processor 304. Main memory 306 also may be used for storing a temporary variable or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312 such as a cathode ray tube (CRT) or liquid crystal display (LCD), for displaying information to a computer user. An input device 314, such as a keyboard including alphanumeric and other keys is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g. x) and a second axis (e.g. y) that allows the device to specify positions in a plane.

An aspect of the example embodiment is related to the use of computer system 300 for Share of Voice analysis. According to an example embodiment, Share of Voice analysis is provided by computer system 300 in response to processor 304 executing one or more sequences of one or more instructions contained in main memory 306. Such instructions may be read into main memory 306 from another computer-readable medium, such as storage device 310. Execution of the sequence of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 304 for execution. Such a medium may take many forms, including but not limited to non-volatile media, volatile media, and transmission media. Non-volatile media include for example optical or magnetic disks, such as storage device 310. Volatile media include dynamic memory such as main memory 306. Transmission media include coaxial cables, copper wire and fiber optics, including the wires that comprise bus 302. Transmission media can also take the form of acoustic or light waves such as those generated during radio frequency (RF) and infrared (IR) data communications. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Various forms of computer-readable media may be involved in carrying one or more sequences of one or more instructions to processor 304 for execution. For example, the instructions may initially be borne on a magnetic disk of a remote computer. The remote computer can load the instructions into its dynamic memory and send the instructions over a telephone line using a modem. A modem local to computer system 300 can receive the data on the telephone line and use an infrared transmitter to convert the data to an infrared signal. An infrared detector coupled to bus 302 can receive the data carried in the infrared signal and place the data on bus 302. Bus 302 carries the data to main memory 306 from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling computer system 300 to a network link 320 that is connected to a local network 322.

For example, communication interface 318 may be a local area network (LAN) card to provide a data communication connection to a compatible LAN. As another example, communication interface 318 may be a modem to provide a data communication connection to a corresponding type of telephone line. Wireless links may also be implemented. In any such implementation, communication interface 318 sends and receives electrical, electromagnetic, or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communications through the worldwide packet data communication network, now commonly referred to as the “Internet” 328.

Computer system 300 can send messages and receive data, including program codes, through the network(s), network link 320, and communication interface 318. In the Internet example, a server 330 might transmit a requested code for an application program through Internet 328, ISP 326, local network 322, and communication interface 318. In accordance with an example embodiment, one such downloaded application provides for share of voice analysis as described herein.

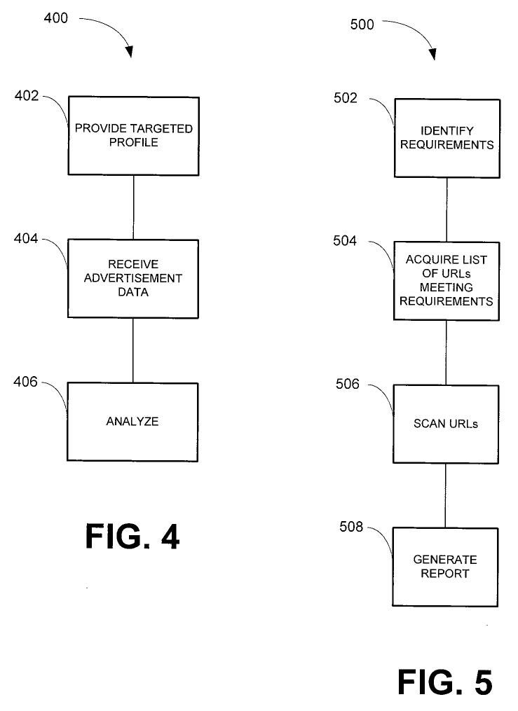

In view of the foregoing structural and functional features described above, methodologies in accordance with example embodiments will be better appreciated with reference to FIGS. 4 and 5. While, for purposes of simplicity of explanation, the methodologies of FIGS. 4 and 5 are shown and described as executing serially, it is to be understood and appreciated that the example embodiments are not limited by the illustrated order, as some aspects could occur in different orders and/or concurrently with other aspects from that shown and described herein. Moreover, not all illustrated features may be required to implement the methodologies described herein. The methodologies described herein are suitably adapted to be implemented in hardware, software, or a combination thereof.

FIG. 4 is a block diagram of a methodology 400 for analyzing advertisements on a web site in accordance with an example embodiment. At 402, data representative of a targeted profile is provided to the device providing the advertising which being analyzed. The data representative of the targeted profile may be sent via a file containing communication history, such as a cookie file, or the data representative of the targeted profile may be provided by simulating user data inputs (e.g. mouse clicks, providing alphanumeric data, etc.)

At 404, data representative of at least one advertisement is received from the device providing the advertising. The data may be in the form of an image, audio data, visual data, audiovisual data, and/or text.

At 406 an analysis is performed on the received data to determine a share of voice for at least one advertiser responsive to receiving data representative of at least one advertisement. The analysis may include determining an advertiser for each set of data representative of at least one advertisement that was received. The analysis may also include determining a total available size for an advertising space, where determining the share of voice comprises determining a total size of advertisements for the at least one advertiser and comparing to the total available size. In an example embodiment, a signal may be sent responsive to determining the share of voice for at least one advertiser is below a predetermined threshold. For example, an advertiser can request to be notified if its share of voice falls below 20% of the share of voice of a group of its competitors. The signal may be in the form of an e-mail, audio alert, visual alert, audiovisual alert, and/or an entry in a log file.

FIG. 5 is a block diagram of a methodology 500 for analyzing advertisements from a plurality of web sites in accordance with an example embodiment. At 502, the requirements, e.g. the advertising space of interest, for the analysis are identified. For example, for an automobile manufacturer the analysis advertising space may include the top 10,000 sites identified with “auto” associated plus desired report info on the top 10 auto manufacturers.

At 504, communication information is obtained for the advertising space. For example, a list URLs for websites meeting the identified requirements are obtained.

At 506, the advertising space is scanned and analyzed. The analysis may include total number of ads and the number of ads by advertiser and/or the total size of the ads and the total size of ads by advertiser. Methodology 400 described in FIG. 4 may be employed for scanning and analyzing each URL.

At 508, a report of the analysis is generated. The results may be monitored and may include real-time signaling to other systems which may be triggered by certain SOV conditions. For example a rule can be implemented where the aggregate SOV percent of an advertisers top 3 competitors should not exceed five times the advertiser's SOV percentage. If such a condition is detected, a signal can be sent to a campaign manager.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus, comprising
a communication interface configured to communicate over an associated network; and
share of voice analysis logic operable to send and receive data via the communication interface;
wherein the share of voice analysis logic is operable to communicate with a device providing advertising coupled to the associated network;
wherein the share of voice analysis logic is operable to provide data representative of a targeted profile to the device providing advertising and to receive data representative of at least one advertisement from the device providing the advertising; and
wherein the share of voice analysis logic is responsive to receiving the data representative of at least one advertisement to analyze the data representative of at least one advertisement to determine a share of voice for at least one advertiser.

2. The apparatus set forth in claim 1, wherein the device providing advertising is a web site and the network is an Internet.

3. The apparatus set forth in claim 2, wherein the share of voice analysis logic provides data of a targeted profile by simulating user data inputs.

4. The apparatus set forth in claim 2, wherein the share of voice analysis logic provides data of a targeted profile by providing a pre-established cookie file.

5. The apparatus set forth in claim 2, wherein the share of voice analysis logic communicates with a plurality of web sites to determine the share of voice for at least one advertiser.

6. The apparatus set forth in claim 2, wherein analyzing the data representative of at least one advertisement by the share of voice analysis logic comprises determining a size of the at least one advertisement.

7. The apparatus set forth in claim 6, wherein the size of the data representative of at least one advertisement is determined by counting pixels.

8. The apparatus set forth in claim 6, wherein the size of the data representative of at least one advertisement is based on a duration of the at least one advertisement.

9. The apparatus set forth in claim 1, wherein the share of voice analysis logic is responsive to determining a share of voice for the at least one advertiser is less than a predetermined threshold to generate a signal indicating the share of voice for the at least one advertiser is below the predetermined threshold.

10. The apparatus set forth in claim 1, wherein the share of voice analysis logic performs an image analysis of the data representative of at least one advertisement to determine an advertiser.

11. The apparatus set forth in claim 1, wherein the share of voice analysis logic performs a text analysis of the data representative of at least one advertisement to determine an advertiser.

12. The apparatus set forth in claim 1, wherein the share of voice analysis logic performs an audio to text conversion and a text analysis of the data representative of at least one advertisement to determine an advertiser.

13. The apparatus set forth in claim 1, wherein the share of voice analysis logic compares signatures of known advertisements with the data representative of at least one advertisement to determine an advertiser.

14. The apparatus set forth in claim 1, wherein the share of voice analysis logic receives data associating at least one advertiser with advertising data; and
wherein the share of voice analysis logic compares the data associating at least one advertiser with advertising data with the data representative of at least one advertisement to determine an advertiser.

15. A method, comprising:
communicating with a device providing advertising coupled to the associated network;
providing data representative of a targeted profile to the device providing advertising;
receiving data representative of at least one advertisement from the device providing the advertising; and
determining a share of voice for at least one advertiser responsive to receiving data representative of at least one advertisement.

16. The method according to claim 15, wherein the providing data representative of a targeted profile comprises simulating user data inputs.

17. The method according to claim 15, wherein the providing data representative of a targeted profile comprises sending a file containing communication history comporting to the targeted profile.

18. The method according to claim 15, wherein determining the share of voice further comprises determining an advertiser for each set of data representative of at least one advertisement.

19. The method according to claim 15, further comprising:
determining a total available size for an advertising space; and
determining the share of voice further comprises determining a total size of advertisements for the at least one advertiser and comparing with the total available s size for the advertising space.

20. Logic encoded in one or more tangible media for execution and when executed operable to:
communicate with a device providing advertising coupled to the associated network;
provide data representative of a targeted profile to the device providing advertising;
receive data representative of at least one advertisement from the device providing the advertising; and
determine a share of voice for at least one advertiser responsive to receiving data representative of at least one advertisement.
